(19) United States
(12) Patent Application Publication
(10) Pub. No.: US 2006/0156872 A1
(43) Pub. Date: Jul. 20, 2006

(54) Wrench operable at any angle

(76) Inventor: Chih-Ching Hsieh, Feng Yuan City (TW)

Correspondence Address: TROXELL LAW OFFICE PLLC, 5205 LEESBURG PIKE, SUITE 1404, FALLS CHURCH, VA, 22041, US

(21) Appl. No.: 11/117,351

(22) Filed: Apr. 29, 2005

(30) Foreign Application Priority Data
Jan. 17, 2005 (TW) 094101350

(51) Int. Cl. B25B 23/16; B25G 1/00

(52) U.S. Cl. 81/177.75; 81/177.8; 81/177.7

(57) ABSTRACT

A wrench includes a handle and a head. A front end of the handle or a rear end of the head is rearward recessed to form a cavity. A ball joint is formed at a rear end of the head or a front end of the handle. A through hole is transversely formed through the ball joint. The joint is mounted in the cavity. A pin member is transversely fitted through the handle or the head and the through hole of the joint, whereby the joint can be rotated within the cavity. Accordingly, the handle can be freely swung relative to the head and the wrench can be operated in different working sites.

### BACKGROUND OF THE INVENTION

The present invention is related to a hand tool, and more particularly to a wrench the handle of which can be freely swung by different angles according to different using conditions.

A wrench is used to wrench a screwed member in various sites. In some cases, a user needs to operate the wrench in a quite narrow space or in a quite hard condition. Under such circumstance, it will be a task to wrench a screwed member.

FIG. 1 shows a conventional wrench 10 having a head 14 pivotally connected with one end of a handle 12. The head 14 can be swung, whereby the angle contained between the head 14 and the handle 12 is changeable according to the working site. Such wrench can be more conveniently used. However, the head 14 can be simply bent up or down by a certain angle. Therefore, the use of such wrench is still quite limited to certain sites.

### SUMMARY OF THE INVENTION

It is therefore a primary object of the present invention to provide a wrench which is operable at any angle. The using mode of the wrench is adjustable according to various working sites. Therefore, the application range of the wrench is widened.

The present invention can be best understood through the following description and accompanying drawings wherein:

### BRIEF DESCRIPTION OF THE DRAWINGS

FIG. 1 is a perspective view of a conventional wrench;

FIG. 2 is a perspective view of a preferred embodiment of the present invention;

FIG. 3 is a perspective exploded view according to FIG. 2;

FIG. 4 is a sectional view taken along line 4-4 of FIG. 2;

FIG. 5 is a sectional view taken along line 5-5 of FIG. 2;

FIG. 6 is a view according to FIG. 4, showing the swing of the head;

FIG. 7 is a front view according to FIG. 2, showing that the handle can be freely swung relative to the head;

FIG. 8 shows the use of the present invention; and;

FIG. 9 is a longitudinal sectional view of another embodiment of the present invention.

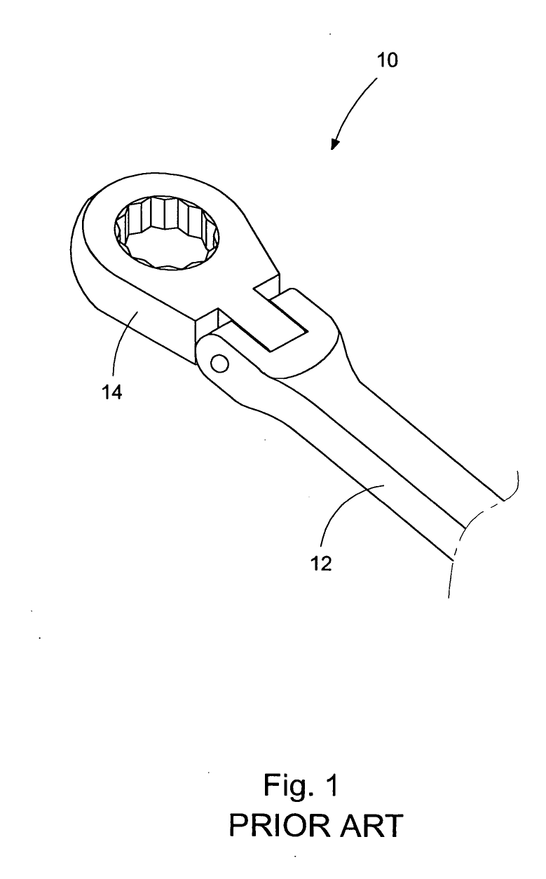

### DETAILED DESCRIPTION OF THE PREFERRED EMBODIMENTS

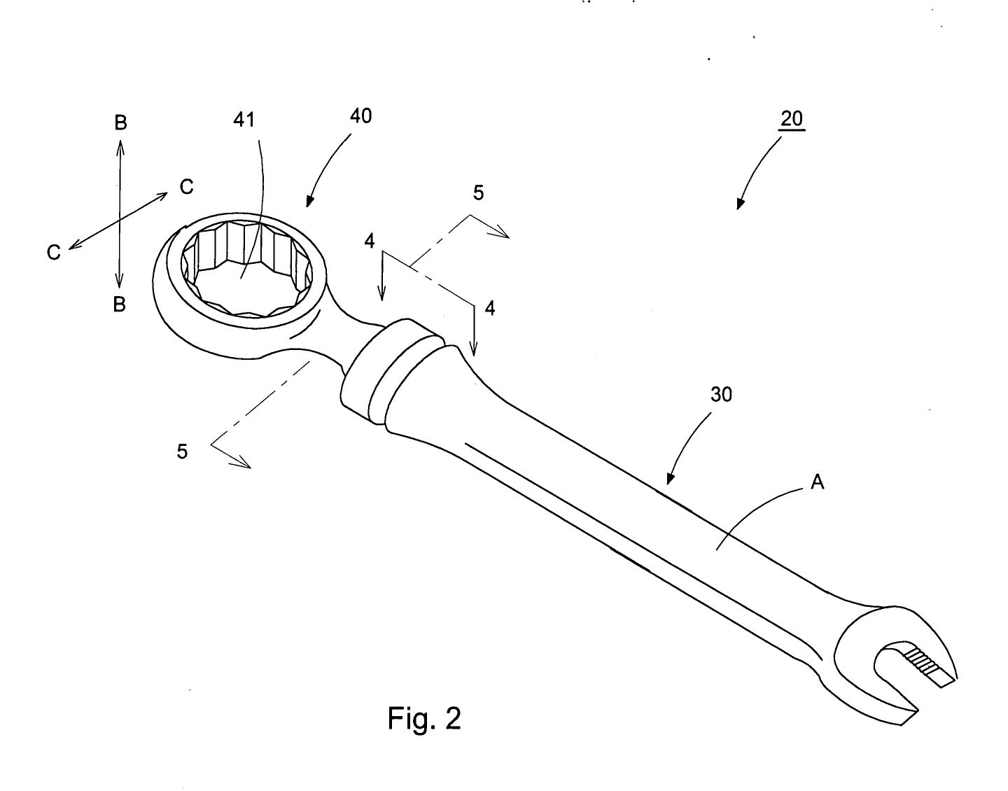

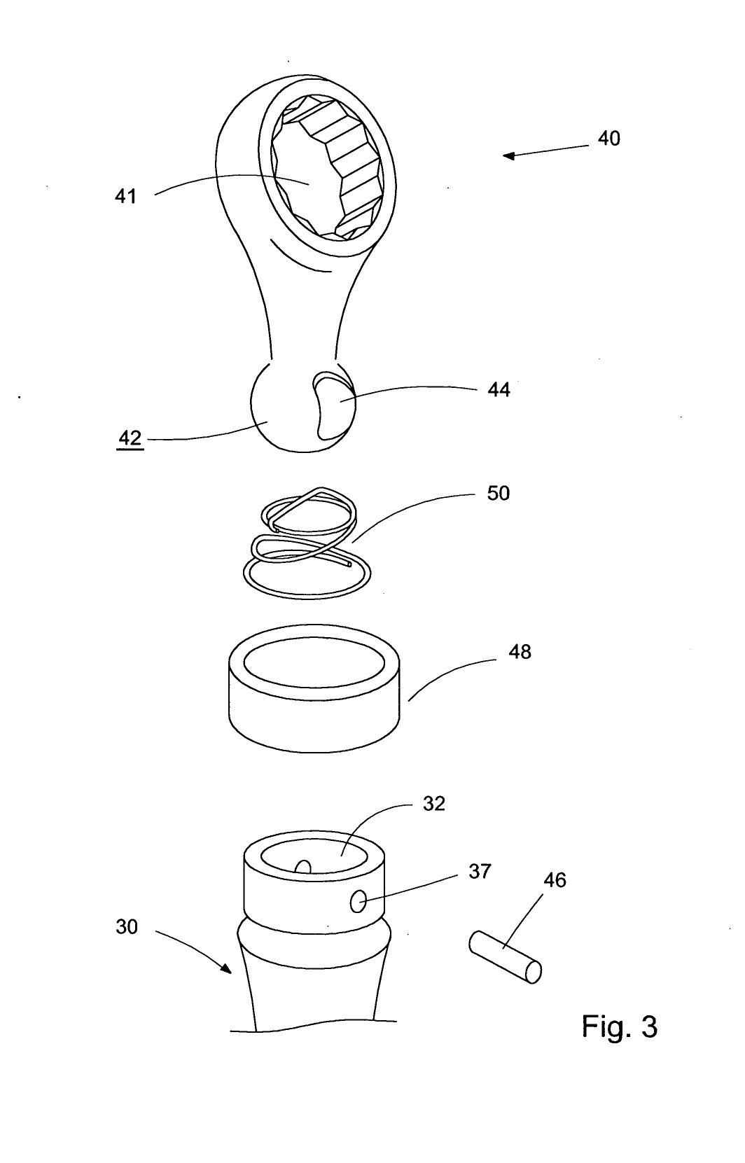

Please refer to FIGS. 2 and 3. The wrench 20 of the present invention has a handle 30 and a head 40 pivotally connected with the handle 30. The handle can be freely swung.

A front end of the handle 30 has a cylindrical shape. The front end of the handle is rearward recessed to form a cavity 32 as shown in FIG. 3.

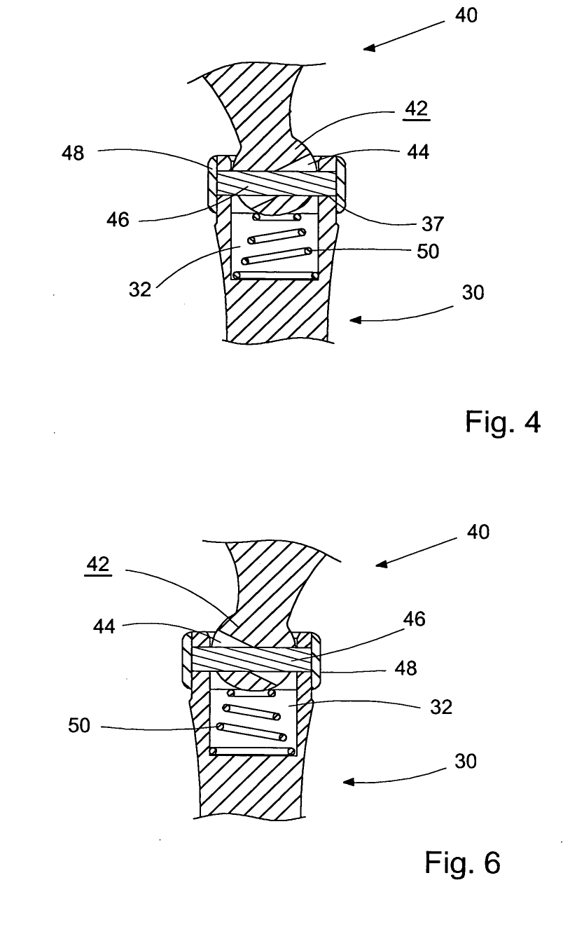

The head 40 can be fitted onto a nut, a bolt or a socket for wrenching the same. In the case of nut or bolt, the head 40 is formed with a polygonal fitting hole 41. In the case of socket, the head is formed with a square insertion column for inserting into an insertion hole of the socket. The head is preferably equipped with a ratchet mechanism. As shown in FIG. 3, a ball joint 42 is formed at rear end of the head 40. A through hole 44 is transversely formed through the ball joint 42. Referring to FIG. 4, preferably, two ends of the through hole 44 have larger width, while the middle of the through hole 44 has smaller width. The ball joint 42 of the head 40 is mounted in the cavity 32 of the handle 30.

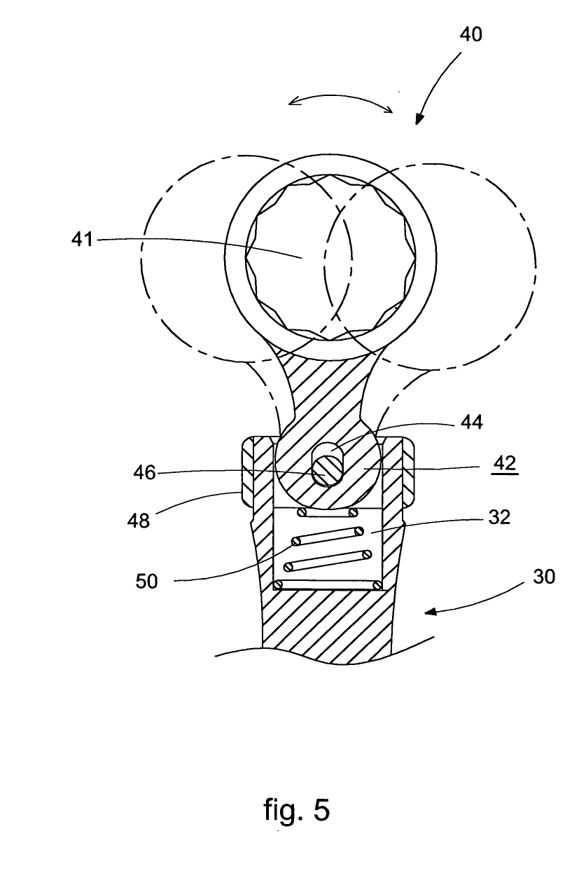

A pin member 46 is fitted through a transverse pivot hole 37 of the front end of the handle and the through hole 44 of the head 40 as shown in FIGS. 4 and 5. Accordingly, the rear end of the head 40 is pivotally connected in the cavity 32 of the handle. A collar 48 is fitted around the front end of the handle to shade the pin member 46 for beautifying the appearance.

A resilient member 50 such as a spring is mounted in the cavity 32. Two ends of the resilient member 50 respectively abut against an inner wall of the cavity and a rear end of the joint 42. Accordingly, the joint is resilientlypushedby the resilient member without loosening and swinging.

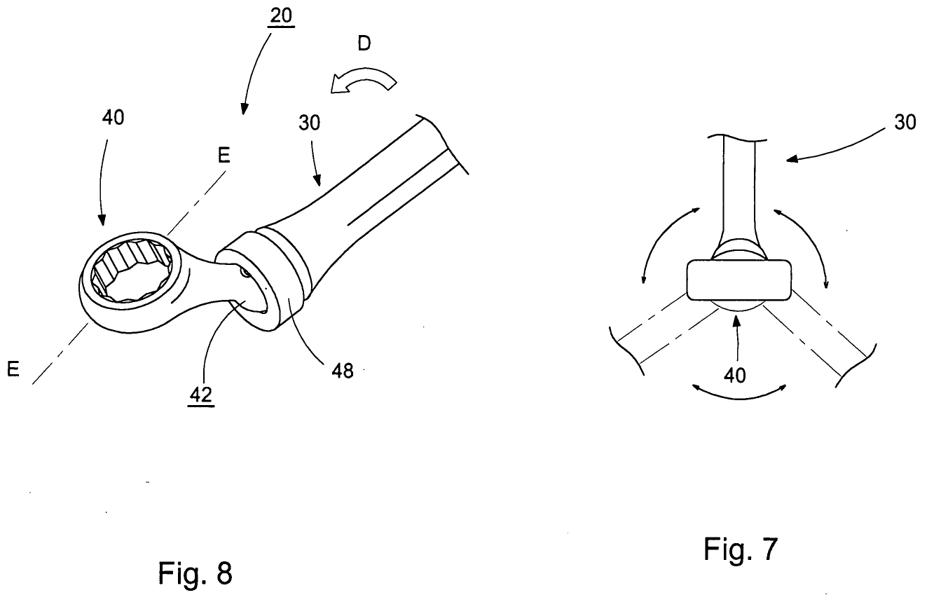

Referring to FIG. 4, the width of the through hole 44 of the joint 42 is larger than the diameter of the pin member 46. Therefore, on a plane formed along the axis of the pin member, the head 40 can be swung about the front end of the handle 30 as shown in FIGS. 4 and 6. The swinging direction is along line B-B of FIG. 2 and perpendicular to the wider face A of the handle 30. Also, referring to FIG. 5, the joint 42 of the head can be rotated about the pin member 46 as shown by the phantom line. This rotational direction is along line C-C of FIG. 2 and parallel to the wider face A of the handle. By means of the complex two-dimensional swinging, as shown in FIG. 7, the handle 30 can be circularly rotated relative to the head 40. Therefore, the handle can be adjusted to any angular position. In different angular positions, the handle is always pushed and positioned by the spring 50.

In use, when the handle 30 is positioned at a dead end of the swing as shown in FIG. 8, the front end of the handle abuts against the rear end of the head 40. At this time, by means of wrenching the handle 30 in direction of arrow D, the head can be wrenched for driving a screwed member or a socket. When the application force of the handle (or a component force of the application force) is applied to the holding face E of the head 40, the head can be effectively wrenched. The handle 30 can be swung to any angular position so that the wrench 20 can be operated in various narrow spaces to drive the head and wrench a screwed member.

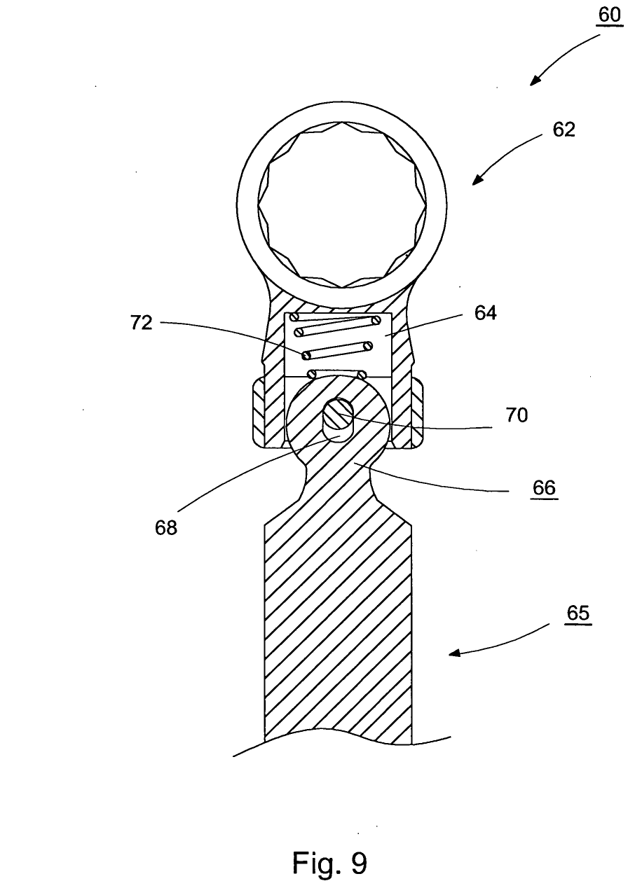

FIG. 9 shows another embodiment of the wrench 60 of the present invention, in which the rear end of the head 62 is inward recessed to form a cavity 64. The front end of the handle 65 is formed with a ball joint 66 having a transverse through hole 68. The joint 66 is fitted in the cavity 64. A pin member 70 is fitted through the head 62 and the through hole 68 of the joint 66, whereby the handle 65 can be freely rotated relative to the head 62. A spring 72 is disposed in the cavity 64 for pushing the joint 66, whereby joint 66 is resiliently forced by the spring 72 to prevent the handle from loosening and swinging.

Similarly, when the handle 65 is positioned at a dead end of the swing, the head 62 can be wrenched. The wrench is operated in different working sites.

The above embodiments are only used to illustrate the present invention, not intended to limit the scope thereof. Many modifications of the above embodiments can be made without departing from the spirit of the present invention.

What is claimed is:

1. A wrench operable at any angle, comprising:
a handle, a front end of the handle being rearward recessed to form a cavity;
a head for fitting with a screwed member or a socket, a ball joint being formed at a rear end of the head, a through hole being transversely formed through the ball joint, the ball joint of the head being mounted in the cavity of the handle; and
a pin member transversely fitted through the front end of the handle and the through hole of the ball joint of the head, the through hole having a diameter larger than the diameter of the pin member, whereby the ball joint can be up and down and left and right swung within the cavity and the handle can be freely swung relative to the head, when the handle is positioned at a dead end of the swing, the handle can be wrenched to wrench the head.

2. The wrench operable at any angle as claimed in claim 1, further comprising a resilient member disposed in the cavity for resiliently pushing the ball joint.

3. The wrench operable at any angle as claimed in claim 1, wherein the front end of the handle is transversely formed with a pivot hole communicating with the cavity, the pin member being fitted in the pivot hole; said wrench further comprising a collar fitted around the front end of the handle for shading the pivot hole.

4. The wrench operable at any angle as claimed in claim 1, wherein the front end of the handle has a cylindrical shape.

5. A wrench operable at any angle, comprising:
a handle, a ball joint being formed at a front end of the handle, a through hole being transversely formed through the ball joint;
a head for fitting with a screwed member or a socket, a rear end of the head being rearward recessed to form a cavity; the ball joint of the handle being mounted in the cavity of the head; and
a pin member transversely fitted through the rear end of the head and the through hole of the ball joint of the handle, the through hole having a diameter larger than the diameter of the pin member, whereby the ball joint can be up and down and left and right swung within the cavity and the handle can be freely swung relative to the head, when the handle is positioned at a dead end of the swing, the handle can be wrenched to wrench the head.

6. The wrench operable at any angle as claimed in claim 5, further comprising a resilient member disposed in the cavity for resiliently pushing the ball joint.

7. The wrench operable at any angle as claimed in claim 5, wherein the rear end of the head is transversely formed with a pivot hole communicating with the cavity, the pin member being fitted in the pivot hole; said wrench further comprising a collar fitted around the rear end of the head for shading the pivot hole.

8. The wrench operable at any angle as claimed in claim 5, wherein the rear end of the head has a cylindrical shape.

9. The wrench operable at any angle as claimed in claim 1 or 5, wherein two ends of the through hole have a larger width, while the middle of the through hole has a smaller width.
